(19) United States
(12) Patent Application Publication
(10) Pub. No.: US 2007/0071515 A1
(43) Pub. Date: Mar. 29, 2007

(54) Heat reflective layer for a fixing unit

(75) Inventors: Deuck-woo Jang, Seongnam-si (KR); Ki-won Seok, Suwon-si (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/493,584

(22) Filed: Jul. 27, 2006

(30) Foreign Application Priority Data
Sep. 29, 2005 (KR) 2005-0091147

(51) Int. Cl. G03G 15/20

(52) U.S. Cl. 399/328

(57) ABSTRACT

A fixing unit includes a heating roller having a heating part, and a pressing roller disposed corresponding to the heating roller. A frame surrounds the heating and pressing rollers and allows a recording medium to pass between the rollers. The frame is mounted with a heat reflective layer on an inner surface thereof. An adiabatic layer may be disposed between the heat reflective layer and the frame. The heat reflective layer may be provided only proximal both sides of the frame when using an adiabatic layer. Accordingly, the initial heating time of the fixing unit, heat loss, and power consumption may be reduced.

### CROSS-REFERENCE TO RELATED APPLICATIONS

This application claims the benefit under 35 U.S.C. § 119(a) of Korean Patent Application No. 2005-91147 filed Sep. 29, 2005, in the Korean Intellectual Property Office, the entire disclosure of which is hereby incorporated by reference.

### BACKGROUND OF THE INVENTION

1. Field of the Invention

The present invention relates to a fixing unit for an image forming apparatus. More particularly, the present invention relates to a fixing unit including a frame having a heat reflective layer.

2. Description of the Related Art

General image forming apparatuses, such as printers and copiers, include a fixing unit for fusing toner particles transferred onto a recording medium by applying heat and pressure. FIG. 1 illustrates a conventional fixing unit.

As shown in FIG. 1, the conventional fixing unit 10 includes a heating roller 11, a pressing roller 13 arranged corresponding to the heating roller 11, and a frame 14 enclosing the two rollers 11 and 13. The heating roller 11 is heated by a heating part 12 to fix toner on a recording medium M. The heating part 12 may include a halogen lamp or a heating coil as a heating source. In FIG. 1, the halogen lamp as a heating source is adopted in the fixing unit 10. A temperature sensor 15 monitors the surface temperature of the heating roller 11 as heated by the heating source.

When the image forming apparatus commands printing, the heating roller 11 is heated to a temperature for fixing the toner. When the heating roller 11 is heated by the heating part 12 up to the temperature required for the fixing, the recording medium M is passed between the heating roller 11 and the pressing roller 13 so that a toner image is fixed on the recording medium M. Performance of the fixing unit depends on how fast it heats up to the fixing temperature. Such a heating speed is one of the important factors that affects the performance of the fixing unit, shortens first-print-out time (FPOT) and determines the initial speed of the image forming apparatus. Another factor determining performance of the fixing unit is maintenance of the fixing temperature during the printing work without heat loss. To shorten a ready time for the printout, the initial heating time for reaching the fixing temperature needs to be reduced and the fixing temperature needs to be maintained without loss of heat.

In the conventional fixing unit, as the recording medium M, which has a relatively lower temperature than the rollers 11 and 13, contacts the rollers 11 and 13, surface temperatures of the rollers 11 and 13 decrease due to the heat loss from the surface of the rollers 11 and 13. For compensation of the decreased temperature, the heating part 12 resumes and continues heating of the heating roller 11, thereby maintaining the fixing temperature. However, even during the continuous heating, heat loss still occurs from the surface of the heating roller 11.

To prevent the heat loss, various techniques have been introduced, such as equipment having an adiabatic layer at the frame of the fixing unit. For example, Japanese Patent Publication No. H9-59596 discloses a fixing unit having an adiabatic layer at a frame thereof to prevent loss of heat. FIG. 2 shows the structure of the above-referenced fixing unit.

Referring to FIG. 2, a fixing unit 20 includes a blocking plate 26 surrounding a heating roller 21. An adiabatic member 28 is attached to the blocking plate 26. A cap 27 thermally isolates a side of the heating roller 21. A frame 24 accommodates the heating roller 21 and the blocking plate 26. Reference numeral 23 denotes a pressing roller, and reference numeral 25 indicates a temperature sensor. In the fixing unit 20, the heating time required by the heating part 22 and power consumption can be reduced by restraining heat transmission from the heating roller 21 to outside of the fixing unit 20. As the image forming apparatuses are developed, however, a fixing unit enabling shorter initial heating time and lower power consumption has been demanded.

Accordingly, a need exists for an image forming apparatus having an improved fixing unit that includes a heat reflective layer.

### SUMMARY OF THE INVENTION

Accordingly, an aspect of the present invention is to provide a fixing unit capable of shortening initial heating time, minimizing loss of heat, and reducing unnecessary power consumption by providing a heat reflective layer to an inside of a frame thereof.

To achieve the above-described aspects of the present invention, a fixing unit includes a heating roller having a heating part, and a pressing roller corresponding to the heating roller. A frame surrounds the heating and pressing rollers, and a recording medium passes between the rollers. The frame is mounted with a heat reflective layer on an inner surface thereof.

The fixing unit may further include an adiabatic layer between the inner surface of the frame and the heat reflective layer. The heat reflective layer may be formed only at both sides of the inner surface of the frame.

The heat reflective layer is made of metal. The metal comprises at least one of the group consisting of aluminum, copper, stainless steel and iron. The heat reflective layer may be bonded to the frame using an adhesive or a fastening member. The heat reflective layer may also be formed by cladding or thermal spray coating.

Other objects, advantages, and salient features of the invention will become apparent from the detailed description, which, taken in conjunction with the annexed drawings, discloses preferred exemplary embodiments of the invention.

### BRIEF DESCRIPTION OF THE DRAWING FIGURES

The above aspect and other features of the present invention will become more apparent by describing in detail exemplary embodiments thereof with reference to the attached drawing figures, wherein;

FIG. 1 is a schematic view of a conventional fixing unit;

FIG. 2 is a schematic view of another conventional fixing unit;

FIG. 3 is a schematic view of a fixing unit according to an exemplary embodiment of the present invention;

FIG. 4A is a side elevational view and FIG. 4B is a front elevational view in partial cross section of a fixing unit according to another exemplary embodiment of the present invention.; and

FIG. 5 is a front elevational view in partial cross section according to yet another exemplary embodiment of the present invention.

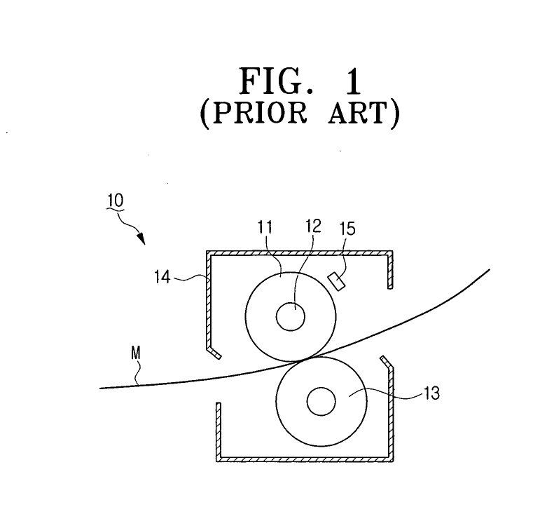

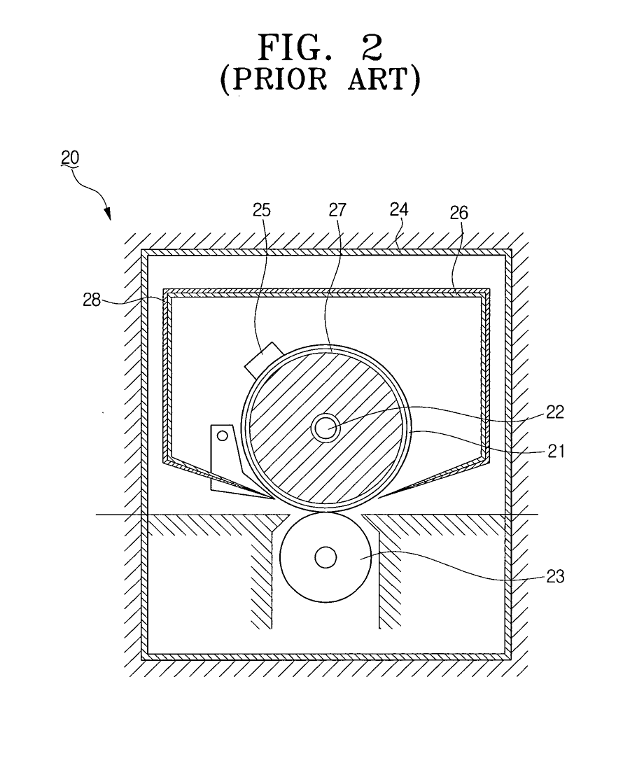

Throughout the drawings, like reference numerals will be understood to refer to like parts, components and structures.

### DETAILED DESCRIPTION OF EXEMPLARY EMBODIMENTS

Hereinafter, exemplary embodiments of the present invention are described in detail with reference to the accompanying drawing figures.

The matters defined in the description, such as a detailed construction and elements thereof, are provided to assist in a comprehensive understanding of the invention. Thus, it is apparent that the present invention may be carried out without those defined matters. Also, well-known functions or constructions are omitted to provide a clear and concise detailed description.

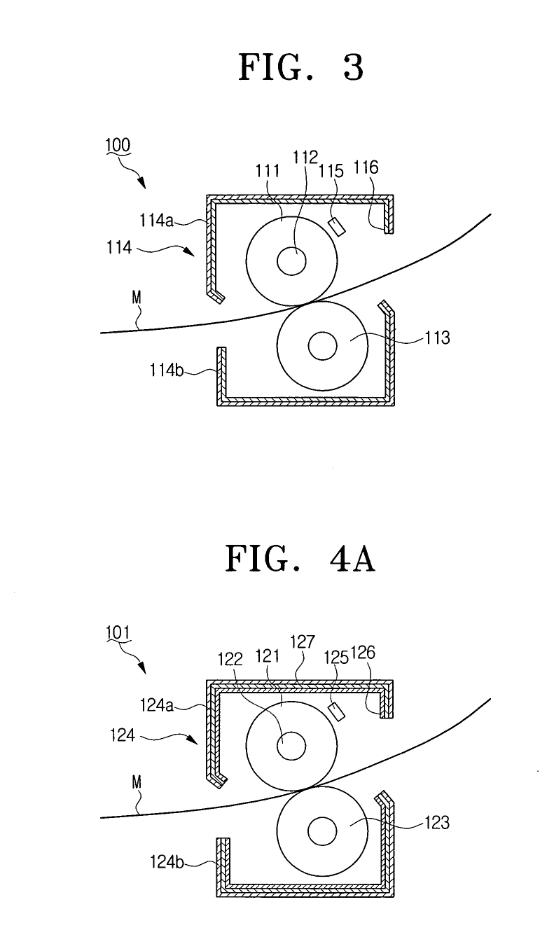

FIG. 3 is a schematic view of a fixing unit according to an exemplary embodiment of the present invention. Referring to FIG. 3, a fixing unit 100 according to an exemplary embodiment of the present invention includes a heating roller 111, a pressing roller 113, and a frame 114. A heat reflective layer 116 is formed on an inner surface of the frame.

The heating roller 111 may have a release layer on its surface and includes a heating part 112 therein. The heating part 112 heats the heating roller 111 up to a fixing temperature for fixing toner on a recording medium M. A halogen lamp or a heating coil may be employed as a heating source for the heating part 112. A temperature sensor 115 monitors the temperature of the surface of the heating roller 111 heated by the heating source.

The pressing roller 113 is disposed to contact the heating roller 111 in a lengthwise direction so that the recording medium M passes between the heating roller 111 and the pressing roller 113.

The frame 114 substantially encloses the rollers 111 and 113 so that the inner heat thereof does not escape to the outside. The frame 114 may include one whole frame. Alternatively, the frame 114 may include upper and lower frames 114a and 114b for more convenient assembling, as shown in FIG. 3. Generally, the frame 114 is made of stainless steel or other suitable steel material. An adiabatic material, such as a ceramic material, may also be used for the frame 114.

The heat reflective layer 116 is formed on the inner surface of the frame 114 in an exemplary embodiment of the present invention. The heat reflective layer 116 reflects heat, which is radiated from the surface of the heating roller 111 by the heating part 112, to the surface of the heating roller 111. Accordingly, the heat reflective layer 116 is capable of minimizing heat loss occurring while heating the fixing unit 100 up to the desired fixing temperature, for example, of approximately 150˜180° C., at the beginning of printing work as well as substantially preventing heat loss occurring during the printing operation.

The heat reflective layer is preferably made of a metal or an alloy including aluminum, copper, stainless steel or iron.

The heat reflective layer 116 may be mounted to the frame 114 in any suitable manner. For example, the heat reflective layer 116 may be bonded to the frame 114 using an adhesive or a fastening member, or formed on the frame 114 by thermal spray coating. The heat reflective layer 116 and the frame 114 may be formed integrally using a clad plate. The thickness of the heat reflective layer 116 is not particularly limited. Preferably, the surface of the heat reflective layer 116 is polished enough for reflection.

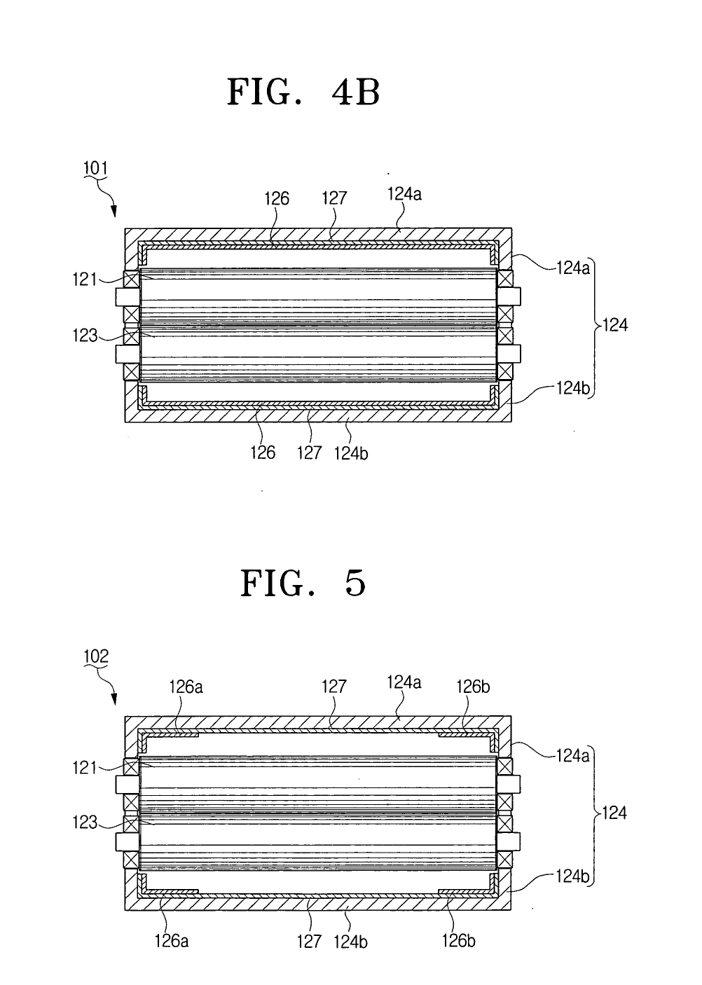

FIG. 4 shows a fixing unit according to a second exemplary embodiment of the present invention. More particularly, FIG. 4A is a side elevational view in partial cross section, and FIG. 4B is a front elevational view in partial cross section. As shown in FIG. 4, a fixing unit 101 further includes an adiabatic layer 127 in addition to a heat reflective layer 126 at an inner surface of a frame 124. The adiabatic layer 127 may be formed of a ceramic material.

According to the fixing unit 101 of FIG. 4, as well as reducing the initial heating time for the fixing unit 101, inner heat of the frame 124 may be preserved by the adiabatic layer 127, thereby saving power required for continuous heating.

Similar to the first exemplary embodiment, the pressing roller 123 is disposed to contact the heating roller 121 in a lengthwise direction so that the recording medium M passes between the heating roller 121 and the pressing roller 123 of the second exemplary embodiment. The frame 124 may include one whole frame, or may include upper and lower frames 124a and 124b for more convenient assembling of the frame.

FIG. 5 is a front elevational view in partial cross section of a fixing unit according to a third exemplary embodiment of the present invention. Referring to the drawing, a fixing unit 102 has a similar structure to the fixing unit 101 of FIG. 4, except that the heat reflective layers 126a and 126b are formed only proximal both sides of the frame 124. Therefore, the fixing unit 102 is able to equalize the surface temperature of a heating roller 121 with respect to a lengthwise direction, as well as reducing the initial heating time and superiorly maintaining the inner heat of the frame 124 by the adiabatic layer 127. In the heating roller 121, generally, minor temperature gradients would be induced along the lengthwise direction although being evenly heated by the heating part 122. More specifically, both end portions of the heating roller 121 are heated slower and cooled faster than a middle portion. In the fixing unit 102 according to a third exemplary embodiment of the present invention, the surface temperature at the both end portions of the heating roller 121 is increased by mounting the heat reflective layers 126a and 126b only proximal both sides of the frame 124, thereby obtaining an even temperature distribution in the heating roller 121.

Hereinafter, an exemplary embodiment of the fixing unit of the present invention will be described in greater detail.

### EXAMPLE 1

A frame having the heat reflective layer and a frame without the heat reflective layer were respectively applied to different fixing units to compare the heating rate in a color printer. A halogen lamp was used as the heating source in both fixing units, and aluminum foil as the heat reflective layer in the one fixing unit having the heat reflective layer.

The fixing units were heated at a normal temperature, thereby measuring the time for reaching the fixing temperature in each fixing unit. The results are shown in [Table 1] as follows:

TABLE 1

| | Initial heating time (sec) | | |
|---|---|---|---|
| Classification | Related art | present invention | Difference (sec) |
| 1^{st} time | 67 | 59 | 8 |
| 2^{nd} time | 66 | 60 | 6 |
| 3^{rd} time | 69 | 58 | 11 |

In [Table 1], the heating time refers to the time (in seconds) elapsed for the fixing unit to be heated from the normal temperature (about 30° C.) to the fixing temperature (about 180° C.).

As may be appreciated from Table 1, the initial heating time was remarkably reduced in the fixing unit having the heat reflective layer according to an exemplary embodiment of the present invention.

### EXAMPLE 2

In this example, heat loss in the fixing unit was compared using two different frames with the heat reflective layer and without the heat reflective layer. All the conditions were the same as in Example 1. After heating the two different fixing units up to the fixing temperature, the time for the two heated fixing units to be cooled to a predetermined temperature was measured. The results are shown in [Table 2] as follows:

TABLE 2

| | Cooling time (sec) | | |
|---|---|---|---|
| Classification | Related art | present invention | Difference (sec) |
| 1^{st} time | 15 | 21 | 6 |
| 2^{nd} time | 17 | 22 | 5 |
| 3^{rd} time | 16 | 23 | 7 |

In [Table 2], the cooling time refers to time elapsed for the fixing unit heated to the fixing temperature to be cooled to approximately 150° C. after removing the heating source.

As shown in [Table 2], in the fixing unit having the heat reflective layer according to an exemplary embodiment of the present invention, the cooling time is relatively longer than in the conventional fixing unit. In other words, the heat reflective layer improves preservation of the inner heat of the frame, thereby decreasing heat loss.

As described above, in the fixing unit having the heat reflective layer, the heat to be lost during heating of the fixing unit may be reused to heat the surface of the heating roller. Consequently, the initial heating time may also be considerably reduced.

Additionally, the fixing unit including both the heat reflective layer and the adiabatic layer at the frame improves preservation of the inner heat of the frame, as well as reducing the initial heating time, thereby reducing the power consumption.

Furthermore, according to exemplary embodiments of the present invention, when the fixing unit includes the heat reflective layers only proximal both sides of the frame together with the adiabatic layer, the surface of the heating roller may be evenly heated with respect to the lengthwise direction. By thus reducing the initial heating time, keeping the inner heat of the frame, and evenly heating the heating roller during the printing operation, time and power may be considerably saved.

While the invention has been shown and described with reference to certain exemplary embodiments thereof, it will be understood by those skilled in the art that various changes in form and details may be made therein without departing from the spirit and scope of the invention as defined by the appended claims.

What is claimed is:

1. A fixing unit, comprising:
a heating roller having a heating part;
a pressing roller disposed corresponding to the heating roller;
a frame surrounding the heating and pressing rollers and allowing a recording medium to pass between the rollers; and
a heat reflective layer mounted on an inner surface of the frame.

2. The fixing unit of claim 1, wherein
an adiabatic layer is disposed between the inner surface of the frame and the heat reflective layer.

3. The fixing unit of claim 1, wherein
the heat reflective layer is made of metal.

4. The fixing unit of claim 3, wherein
the metal includes at least one of aluminum, copper, stainless steel and iron.

5. The fixing unit of claim 1, wherein
the heat reflective layer is bonded to the frame using an adhesive.

6. The fixing unit of claim 1, wherein
the heat reflective layer is bonded to the frame using a fastening member.

7. The fixing unit of claim 1, wherein
the heat reflective layer is formed by thermal spray coating.

8. The fixing unit of claim 1, wherein
the heat reflective layer is integrally formed with the frame using a cladding member.

9. The fixing unit of claim 2, wherein
the heat reflective layer is formed proximal at least one side of the inner surface of the frame.

10. The fixing unit of claim 2, wherein
the adiabatic layer is formed of a ceramic material.

11. The fixing unit of claim 1, wherein
the frame has an upper portion and a lower portion configured to pass the recording medium.

12. An image forming apparatus, comprising:
an image forming unit;
a frame having an upper portion and a lower portion disposed within the image forming unit;
a heating roller disposed within the frame and having a heating part;
a pressing roller disposed within the frame to contact the heating roller;
a heat reflective layer mounted on an inner surface of the upper and lower portions of the frame; and
an adiabatic layer disposed between the heat reflective layer and the upper and lower portions of the frame.

13. An image forming apparatus of claim 12, wherein
the heat reflective layer is made of metal.

14. An image forming apparatus of claim 13, wherein
the metal includes at least one of aluminum, copper, stainless steel and iron.

15. An image forming apparatus of claim 12, wherein
the heat reflective layer is bonded to the upper and lower portions of the frame using an adhesive.

16. An image forming apparatus of claim 12, wherein
the heat reflective layer is bonded to the upper and lower portions of the frame using a fastening member.

17. An image forming apparatus of claim 12, wherein
the heat reflective layer is formed by thermal spray coating.

18. An image forming apparatus of claim 12, wherein
the heat reflective layer is integrally formed with the frame using a cladding member.

19. An image forming apparatus of claim 12, wherein
the heat reflective layer is formed proximal both sides of the inner surface of the upper and lower portions of the frame.

20. An image forming apparatus of claim 13, wherein
the adiabatic layer is formed of a ceramic material.
